(19) United States
(12) Patent Application Publication
(10) Pub. No.: US 2023/0404035 A1
(43) Pub. Date: Dec. 21, 2023

(54) PASSIVE SAFE ANTI-PINCH TRACTION ROPE

(71) Applicant: Lingwang (Dongguan) Technology Co., Ltd., Dongguan (CN)

(72) Inventor: Shimin LIU, Dongguan (CN)

(21) Appl. No.: 17/842,834

(22) Filed: Jun. 17, 2022

(51) Int. Cl. A01K 27/00; F16B 2/16

(52) U.S. Cl. CPC A01K 27/005; A01K 27/003; F16B 2/16

(57) ABSTRACT

The present invention provides a passive safe anti-pinch traction rope, comprising a traction rope body and a hook. A linking device is connected between the traction rope body and the hook, and one end of the hook is provided with a first ball limiting groove. The linking device comprises a linking outer shell, a linking piece and a connecting piece. The hook is detachably connected with the linking device by means of the cooperation of a first ball and the first ball limiting groove. The connecting piece is detachably connected by means of the cooperation of a second ball, and a second ball limiting groove. According to the present invention, the connection can be removed rapidly in case of emergency.

### FIELD OF TECHNOLOGY

The present invention relates to the field of pet appliances, particularly to a passive safe anti-pinch traction rope.

### BACKGROUND

At present, there are increasing people raising pets, the behavior of walking pets is more and more common. When people walk their pets, use of a traction rope is a conduct standard which should be abided by every pet raising person, which not only has no adverse effect to the public environment and lives of other people, but also prevents occurrence of other accidents.

There are other accidents therewith while using the traction rope.

We may often see a number of reports of accidents of pets in elevators in online videos. Common descriptions in the reports are that when pet owners take the elevators with pets, pets and the pet owners are spaced on two sides of the elevator doors due to various reasons at the movement of coming in and going out of the elevators, and the pet owners are insensible or without any awareness in the process, and thus, the elevators are unable to identify obstacles and close the elevator doors to operate. After the elevator doors are closed, the traction ropes for pets cannot be loosened from the gaps of the elevator doors and are clamped by the elevator doors, and the elevators operate to pull the traction ropes for the pets, resulting in a tragedy that the pets are strangled.

Therefore, it is a need to design a traction rope capable of timely relieving the connection between the traction rope and the pet to save the pet timely, so that similar tragedies are prevented from occurring again.

### SUMMARY

The present invention is intended to provide a passive safe anti-pinch traction rope. The traction rope can be removed from a pet collar rapidly, and a hook end can fall off automatically when a pet is forgotten outside an elevator door and the traction rope is clamped between the elevator doors, so that harms that the pet is strangled and the like are avoided.

In order to achieve the objective, the present invention provides a technical scheme as follows:

a passive safe anti-pinch traction rope includes a traction rope body and a hook, wherein a linking device is connected between the traction rope body and the hook, and one end of the hook is provided with a first ball limiting groove; the linking device includes a linking outer shell, a linking piece disposed in the linking outer shell and a connecting piece, one end of the connecting piece is connected with the traction rope body iii a sleeving manner and the other end of the connecting piece is provided with a second ball limiting groove; a first ball and a second ball are arranged between the linking piece and the linking outer shell, the hook is detachably connected with the linking device by means of the cooperation of a first ball and the first ball limiting groove; and the connecting piece is detachably connected by means of the cooperation of a second ball and a second ball limiting groove.

Further, the linking device is further internally provided with a spring, the spring being nested on an outer pipe wall of the linking piece.

Further, one end of the linking piece is provided with a hook mounting, hole for inserting the hook, and the other end of the linking piece is provided with a connecting piece mounting hole for inserting the connecting piece; the outer pipe wall at one end of the linking piece is further provided with a first ball locking hole for mounting the first ball, and the first ball is connected with the hook in a clamping manner through the first ball locking hole; the outer pipe wall at the other end of the linking piece is provided with a second ball locking hole for mounting the second ball, and the second ball is connected with the connecting piece in a clamping manner through the second ball locking hole; and the first ball is connected in the first ball limiting groove in a clamped manner through the first ball locking hole, and the second ball is connected in the second ball limiting groove in a clamped manner through the second ball locking hole.

Further, the linking outer shell is a hollow tubular structure internally provided with a stepped hole, a first ball locking hole section, a first ball unlocking hole section, a linking piece limiting hole section, a second ball locking hole section and a second ball unlocking hole section are successively arranged from one end to the other end of a pipe hole of the linking outer shell, a pore diameter of the first ball unlocking hole section is greater than a pore diameter of the first ball locking hole section, a pore diameter of the second ball unlocking hole section is greater than a pore diameter of the second ball locking hole section, and a pore diameter of the linking piece limiting hole section is greater than the pore diameter of the second ball locking hole section.

Further, the linking piece comprises a first stepped shaft section and a second stepped shaft section, wherein an outer pipe diameter of the first stepped shaft section is greater than an outer pipe diameter of the second stepped shaft section; and the pore diameter of the linking piece limiting hole section is smaller than the outer pipe diameter of the first, stepped shaft, section.

Further, the first ball locking hole section is in clearance fit with the first stepped shaft section, and the second ball locking hole section is in clearance fit with the second stepped shaft section.

Further, transition walls on the upper and lower sides of the first ball unlocking hole section are in transition arrangements of inclined planes, and a transition wall between the second ball unlocking hole section and the second ball locking hole section is in a transition arrangement of an inclined plane, so that the first ball and the second ball are in smooth transition at a joint of two adjacent inner hole walls of the stepped hole in the linking outer shell.

Further, transition walls on the upper and lower sides of the second ball limiting groove are in a transition arrangement of an inclined plane, so that it is convenient for the hook to push the second ball.

Further, the spring is nested on the outer pipe wall of the second stepped shaft section of the linking piece, the linking piece nested with the spring is inserted into the linking outer shell of the first ball locking hole section, one end of the spring abuts against a shaft shoulder between the first ball locking hole section and the second ball locking hole section, and the other end of the spring abuts against a hole shoulder between the linking piece limiting hole section and the second ball locking hole section. The linking piece can be restored through a restoring force of the spring when moving downwards relative to the linking outer shell.

Further, the outer pipe wall at the lower end of the second stepped hole section of the linking piece is provided with a limiting piece mounting groove, and a limiting ring piece is nested in the limiting piece mounting groove; and the limiting ring piece is used for limiting the linking piece in the linking outer shell to limit the linking piece to move upwards outside the linking outer shell.

Further, the passive safe anti-pinch traction rope further includes a traction rope outer sleeve, the traction rope outer sleeve is sleeved on the outer surface of the linking outer shell, an outer side of the upper end of the linking outer shell is provided with a peripheral protrusion, the lower end of the linking outer shell is provided with a traction rope outer sleeve slot, and the traction rope outer sleeve slot is used for limiting and connecting the traction rope outer sleeve in a clamping manner.

Further, the first ball locking hole is formed in the first stepped shaft section, and a pore diameter thereof in one side of the hook mounting groove is smaller than a diameter of the first ball, so that the first ball is prevented from rolling outwards into the linking piece from the first ball locking hole. The second ball locking hole is formed in the second stepped shaft section outside the connecting piece mounting hole, and a pore diameter thereof in one side of the hook mounting groove is smaller than a diameter of the second ball, so that the second ball is prevented from rolling from the inner side of the second ball locking hole, and a part of the ball enters the connecting piece mounting hole through the second ball locking hole.

It can be known from analysis that the present invention discloses a passive safe anti-pinch traction rope. The traction rope can be removed from a pet collar rapidly, and a hook end can fall off automatically through relative slip between the linking outer shell and the linking piece under emergency circumstances that a pet is forgotten outside an elevator door and the traction rope is clamped between the elevator doors, so that harms that the pet is strangled and the like are avoided. After the hook connected with the pet collar is unlocked, the connecting piece pulled by the traction rope is separated from the linking piece to prevent the damage to the elevator as the linking device is clamped at the elevator doors when the elevator operates upwards, so that there are no elevator, accidents.

### BRIEF DESCRIPTION OF THE DRAWINGS

The drawings of the description constituting a part of the disclosure are to provide further understanding of the present invention. The schematic embodiment and description thereof are used for explaining the present invention and do not limit the present invention improperly. In the drawings,

FIG. 1 is a structural schematic diagram of an embodiment of the present invention.

FIG. 2 is a schematic diagram of an exploded structure of an embodiment of the present invention.

FIG. 3 is a schematic diagram of a longitudinal section of a linking outer shell of an embodiment of the present invention.

FIG. 4 is a schematic diagram of a longitudinal section of a linking piece of an embodiment of the present invention.

FIG. 5 is a structural schematic diagram of a connecting piece of an embodiment of the present invention.

FIG. 6 is a three-dimensional structural schematic diagram of an embodiment of the present invention.

FIG. 7 is a sectional schematic diagram of a connecting and locking state of a linking device of an embodiment of the present invention. FIG. 8 is a sectional schematic diagram of a connecting state of a linking device of an embodiment of the present invention.

FIG. 9 is a sectional schematic diagram of a hook connection relieving state of a linking device of an embodiment of the present invention.

FIG. 10 is a sectional schematic diagram of an instantaneous state of a linking device relieving a hook and a connecting piece of an embodiment of the present invention.

### DESCRIPTION OF NUMERALS IN DRAWINGS

1-traction rope; 2-linking device; 3-hook; 21-traction rope outer sleeve; 22-linking outer shell; 23-linking piece; 24-connecting piece; 25-first ball; 26-second ball; 27-spring; 28-limiting ring piece; 221-first ball locking hole section; 222-first ball unlocking hole section; 223-linking piece limiting hole section; 224-second ball locking hole section; 225-second ball unlocking hole section; 226-traction rope outer sleeve slot; 227-outer edge protrusion; 231-first stepped shaft section; 232-second stepped shaft section; 233-hook mounting hole; 234-first ball locking hole; 235-connecting piece mounting hole; 236-second ball locking hole; 237-limiting piece mounting groove; 241-second ball limiting groove; 301-first ball limiting groove.

### DETAILED DESCRIPTION OF THE EMBODIMENTS

Detail description on the present invention will be made below in combination with the drawings and the embodiments. Each example is provided by the present invention in an explained manner rather than limits the present invention. Actually, those skilled in the art clearly understand that modifications and variations on the present invention can be made without departing the scope or the spirit of the present invention. For example, features of a part depicted or described as one embodiment can be used for another embodiment to generate yet another embodiment. Thus, it is expected that the present invention comprises modifications and variations classified into the scope of the, attached claims and equivalents thereof.

In description of the present invention, orientation or position relationships indicated by terms: ‘longitudinal’, ‘transverse’, ‘upper’, ‘lower’, ‘front’, ‘back’, ‘left’, ‘right’, ‘vertical’, ‘horizontal’, ‘top’, ‘bottom’ and the like are orientation or position relationships indicated by the drawings and are only to describe the present invention and simplify the description rather than indicates or implies that the indicated device or components must have specific orientations. Therefore, it cannot be construed as limitations to the present invention. Terms ‘connecting’, ‘connection’ and ‘arrange’ used in the present invention should be understood in a broad sense, for example, ‘connecting’, ‘connection’ and ‘arrange’ can be either fixed connection or detachable connection; can be either directly connection or connection via intermediate parts; and can be either wired electric connection and wireless electric connection or wireless communication signal connection. Those skilled in the art can understand specific meanings of the terms according to specific conditions.

The attached drawings depict one or more examples of the present invention. Detailed description utilizes number and letter marks to substitute features in the drawings. Similar or analogous marks in the drawings and description have been used for substituting similar or analogous parts of the present invention. As used herein, the terms ‘first’, ‘second’, ‘third’ and the like can be used interconvertibly to separate one component from the other one and do not, aim to represent position or importance of a single component.

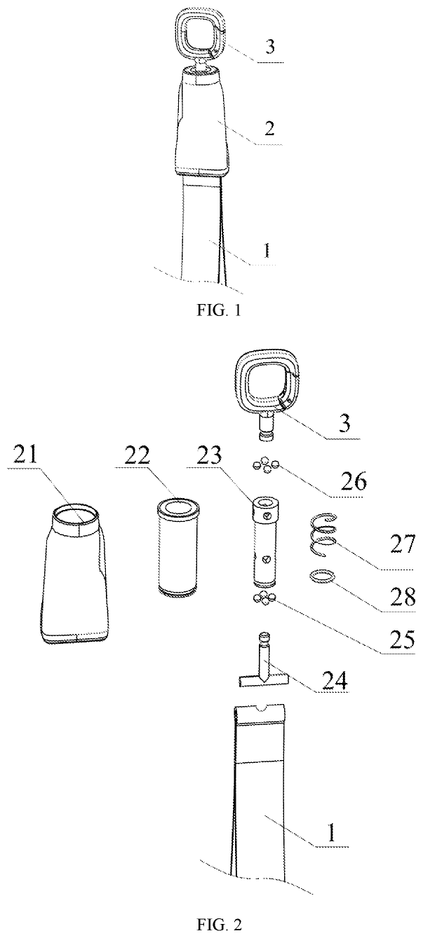

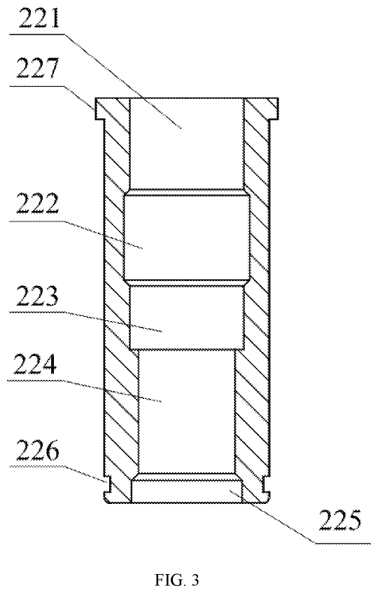

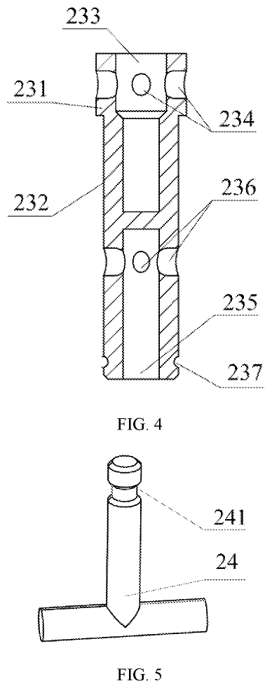

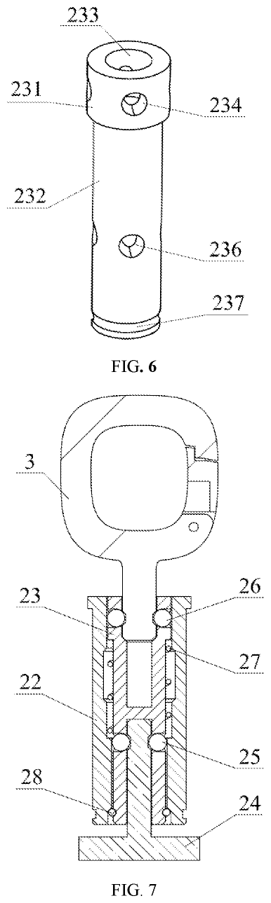

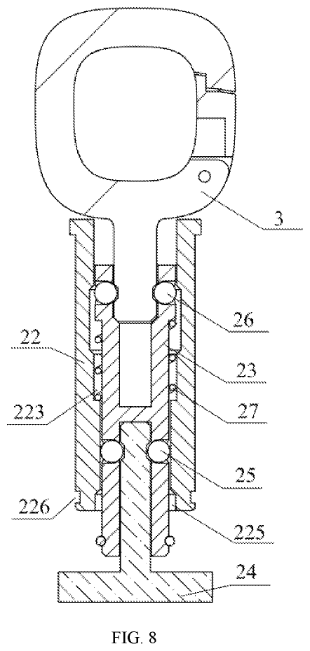

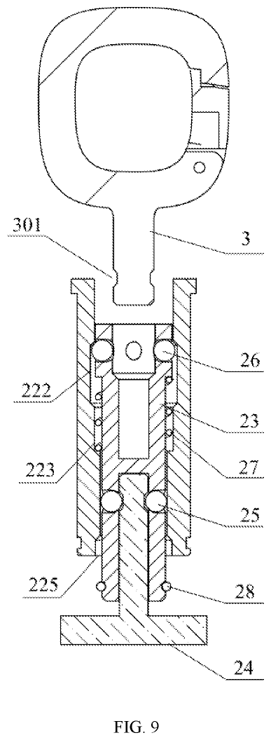

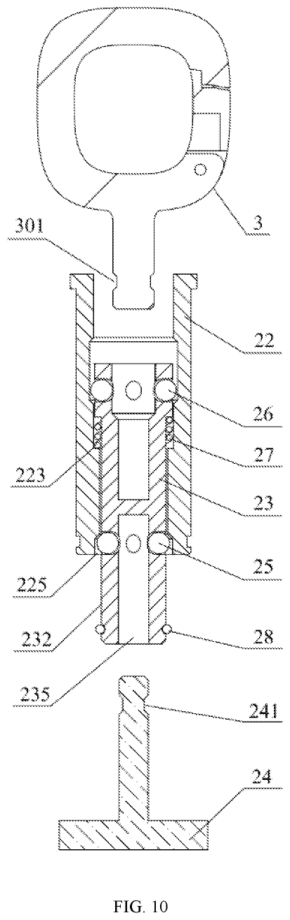

As shown in FIG. 1 to FIG. 10, according to the embodiments of the present invention, provided is a passive safe anti-pinch traction rope, including a traction rope body 1, a linking device 2 and a hook 3, wherein the traction rope 1 is detachably and fixedly connected with one end of the linking device 2, and one end of the hook 3 is detachably and fixedly connected with the other end of the linking device 2. One end of the traction rope 1 is provided with a connecting piece 24, one end of the connecting piece 24 is non-detachably and fixedly connected with the traction rope 1 and the other end of the connecting piece 24 is detachably and fixedly connected with the linking device 2.

The linking device 2 includes a linking outer shell 22, a linking piece 23, a first ball 25 and a second ball 26, wherein the linking piece 23 is internally disposed in the linking outer shell 22, the first ball 25 is embedded onto the upper portion of the linking piece 23, and the second ball 26 is embedded onto the lower portion of the linking piece 23. The hook 3 is inserted into the linking piece 23 from the upper end portion of the linking piece 23 and the hook 3 is clamped by the first ball 25, so that the hook 3 is fixed in the linking piece 23. When the hook 3 locked by the first ball 25 is unlocked, the hook 3 then can be separated from the linking piece 23. The connecting piece 24 is inserted into the linking piece 23 from the, lower end of the linking piece 23 and is clamped by the second ball 26, so that the connecting piece 24 is fixed in the linking piece 23. When the connecting piece 24 locked by the second ball 26 is, unlocked, the connecting piece 24 then can be separated from the linking piece 23.

The linking piece 23 is a stepped shaft structure slotted from two ends inwards, a first stepped shaft section 231 is arranged above the linking piece 23, a second stepped shaft section 232 is arranged below the first stepped shaft section 231, a shaft diameter of the first stepped shaft section 231 is greater than a shaft diameter of the second stepped shaft section 232, the first stepped shaft section 231 is internally provided with a hook mounting hole 233, a side of the hook mounting hole 233 is radially provided with a plurality of first ball locking holes 234, the first ball locking holes 234 are communicated with the hook mounting hole 233, a depth of each of the first ball locking holes 234 is smaller than a diameter of the first ball 25, the first ball is placed from the outer side of the first ball locking hole 234 in the first ball locking hole 234, and a pore diameter of an inner side of the first ball locking hole 234 is smaller than the diameter of the first ball 25, so that the first ball 25 will not roll out from the inner side of the first ball locking hole 234 and a part of the ball is exposed in the hook mounting hole 233 through the first ball locking hole 234, the lower end of the second stepped shaft section 232 is provided with a connecting piece mounting hole 235, a side of an upper portion of the connecting piece mounting hole 235 is radially provided with several second ball locking holes 236, the second ball locking holes 236 are communicated with the connecting piece mounting hole 235, the first ball 26 is placed from the outer side of the second ball locking hole 236 in the second ball locking hole 236, and a pore diameter of an inner side of the second ball locking hole 236 is smaller than the diameter of the second ball 26, so that the second ball 26 will, not roll out from the inner side of the second ball locking hole 236 and a part of the ball is exposed in the connecting piece mounting hole 235 through the second ball locking hole 236. The hook 3 and the connecting piece 24 are connected at two ends of the linking piece 23 in a clamped manner through the first ball 25 and the second ball 26.

The linking outer shell 22 is a hollow tubular structure internally provided with a stepped hole, a first ball locking hole section 221 is arranged at an upper opening of the linking outer shell 22, a pore diameter of the first ball locking hole section 221 is identical to an outer diameter of the first stepped shaft section 231 of the linking piece 23, and when the first stepped shaft section 231 provided with the first ball 25 is located in the first ball locking hole section 221, the first ball 25 is exposed in the hook mounting hole 233 through the first ball locking hole 234 to lock the hook 3.

The stepped hole section below the first ball locking hole section 221 is a first ball unlocking hole section 222, an inner diameter of the first ball unlocking hole section 222 is greater than the inner diameter of the first ball locking hole section 221, and when the first stepped shaft section 231 provided with the first ball 25 is located in the first ball unlocking hole section 222, a part of the first ball 25 exposed in the hook mounting hole 233 through the first ball locking hole 234 may be moved out of the hook mounting hole 233 to unlock the hook 3. Transition walls on the upper and lower sides of the first ball unlocking hole section 222 are in transition arrangements of inclined planes, so that the balls are in smooth transition between the stepped hole sections.

A linking piece limiting hole section 223 is arranged below the first ball unlocking hole section 222, an inner diameter of the linking piece limiting hole section 223 is equal to the inner diameter of the first ball locking hole section 221, a stepped hole section below the linking piece limiting hole section 223 is provided with a second ball locking hole section 224, and a pore diameter of the second ball locking hole section 224 is equal to a shaft diameter of the lower stepped shaft section 232, thereby preventing the first stepped shaft section 231 of the linking piece 23 from moving downwards. When the second stepped shaft section 232 provided with the second ball 26 is located in the second ball locking hole section 224, the second ball 26 is exposed in the connecting piece mounting hole 235 through the second ball locking hole 236 to lock the connecting piece 24.

A second ball unlocking hole section 225 is arranged below the second ball locking hole section 224, an inner diameter of the second ball unlocking hole section 225 is greater than the shaft diameter of the second stepped shaft section 232 of the linking piece 23, and when the second stepped shaft section 232 provided with the second ball 26 is located in the second ball unlocking hole section 225, a part of the second ball 26 exposed in the connecting piece mounting hole 235 may be moved out of the connecting piece mounting hole 235 to unlock the connecting piece 24. Transition walls between a second ball unlocking hole section 225 and the second ball locking hole section 224 are in transition arrangements of inclined planes, so that the second ball 26 rolls conveniently.

The linking outer shell (22) is sleeved on the outer side of the linking piece (23), and the linking piece (23), the spring (27), the first ball (25) and the second ball (26) are arranged in the linking outer shell (22); the linking outer shell (22) is able to slide up and down relative to the linking piece (23) through the first ball (25) and the second ball (26); the second stepped shaft section 232 of the linking piece 23 is provided with the spring 27 in a sleeving manner, the linking piece 23 sleeving the spring 27 is inserted into the linking outer shell from the first ball locking hole section 221, one end of the spring 27 abuts against a shaft shoulder between the first stepped shaft section 231 and the second stepped shaft section 232, and the other end of the spring 27 abuts against a hole shoulder between the linking piece limiting hole section 223 and the second ball locking hole section 224. When the linking piece 23 moves downwards relative to the linking outer shell 22, the linking piece 23 may be restored through a restoring force of the spring 27.

The outer pipe wall at the lower end of the second stepped hole section 232 of the linking piece 23 is provided with a limiting piece mounting groove 237, and a limiting ring piece 28 which is circular is nested in the limiting piece mounting groove 237; and an outer diameter of the limiting ring piece 28 is greater than the outer diameter of the second ball locking hole section 224, and the limiting ring piece 28 is used for limiting the linking piece 23 in the linking outer shell 22 to limit the linking piece 23 to move upwards outside the linking outer shell 22.

A connecting end of the hook 3 is provided with a first ball limiting groove 301, and transition walls on the upper and lower sides of the first ball limiting groove 301 are in a transition arrangement of an inclined plane, so that the balls roll conveniently.

A connecting end of the connecting piece 24 is provided with a second ball limiting groove 241, and transition walls on the upper and lower sides of the second ball limiting groove 241 are in a transition arrangement of an inclined plane, so that the balls roll conveniently.

The present invention further includes a traction rope outer sleeve 21 sleeving the linking outer shell 22, the lower end of the linking outer shell 22 is provided with a traction rope outer sleeve slot 226, and an outer side of the upper end of the linking outer shell 22 is provided with an outer edge protrusion 227, which are respectively used for limiting and clamping the traction rope outer sleeve.

In the using process of the passive safe anti-pinch traction rope provided by the present invention, the hook 3 is hung on the pet collar. When the pet is forgotten outside the elevator, the elevator doors are closed to clamp the traction rope 1 therebetween and the elevator moves upwards, the linking, device 2 will be clamped at a door slot of the elevator doors. With the ascending elevator, the traction rope will be pulled tightly, the linking outer shell 22 will move toward one end of the hook 3 relatively, the linking piece 23 slides relative to the liking outer shell 22, and the first ball 25 rolls into the first ball unlocking hole section 222. At the time, the hook 3 rolls out under the action of gravity of the pet or a backward struggling force, the pet will be prevented from being curbed. When the traction rope 1 is pulled tightly continuously, the linking piece 23 slides towards the traction rope 1 relative to the linking outer shell 22. When the second ball 26 is located in the second ball unlocking hole section 225, the second ball 26 unlocks the connecting piece 24, the connecting piece 24 pulled by the traction rope 1 is separated from the linking piece 23 to prevent the damage to the elevator as the linking device 2 is clamped at the elevator doors when the elevator moves upwards, thereby preventing elevator accidents from occurring.

It can be seen from the above description that the above-mentioned examples achieve the following technical effects:

1. The traction, rope may be removed from a pet collar rapidly, and a hook end may fall off automatically when a pet is forgotten outside an elevator door and the traction rope is clamped between the elevator doors, so that harms that the pet is strangled and the like are avoided;

2. After the hook connected with the pet collar is unlocked, the connecting piece pulled by the traction rope is separated from the linking piece to prevent the damage to the elevator as the linking device is clamped at the elevator doors when the elevator operates upwards, so that there are no elevator accidents.

Compared with the prior art, the connection of the passive safe anti-pinch traction rope provided by the present, invention can be removed rapidly in case of emergency. The connection can be relieved passively when the pet owner does not realize that the pet is forgotten outside the elevator doors, so that tragedies are effectively prevented from occurring. The outer shell of the linking device can be passively removed to prevent influence of metal parts on operation of the elevator, so that there are no elevator accidents.

The above is merely preferred embodiments of the present invention and is not used to limit the present invention. For those skilled in the art, various alternations and changes can be made on, the present invention. Any modification, equivalent replacement, improvement, etc. made within the spirit and principle of the present invention shall be regarded as within the protection scope of the present invention.

1. A passive safeguard anti-pinch traction rope, comprising a traction rope body and a hook, wherein a linking device is connected between the traction rope body and the hook, and one end of the hook is provided with a first ball limiting groove; the linking device comprises a linking outer shell, a linking piece disposed in the linking outer shell and a connecting piece, one end of the connecting piece, is connected with the traction rope body in a sleeving manner and the other end of the connecting piece is provided with a second ball limiting groove; a first ball and a second ball are arranged between the linking piece and the linking outer shell, the hook is detachably connected with the linking device by means of the cooperation of the first ball and the first ball limiting groove; and the connecting piece is detachably connected, by means of the cooperation of the second ball and the second ball limiting groove.

2. The passive safe anti-pinch traction rope according to claim 1, wherein the linking device is further internally provided with a spring, the spring being nested on an outer pipe wall of the linking piece.

3. The passive safe anti-pinch traction rope according to claim 2, wherein one end of the linking piece is provided with a hook mounting hole for inserting the hook, and the other end of the linking piece is provided with a connecting piece mounting hole for inserting the connecting piece; the outer pipe wall at one end of the linking piece is further provided with, a first ball locking hole for mounting the first ball, and the first ball is connected with the hook in a clamping manner though the first ball locking hole; the outer pipe wall at the other end of the linking piece is provided with a second ball locking hole for mounting the second ball, and the second ball is connected with the connecting piece in a clamping manner through the second ball locking hole; and the first ball is connected in the first ball limiting groove in a clamped manner through the first ball locking hole, and the second ball is connected in the second ball, limiting groove in a clamped manner though the second ball locking hole.

4. The passive safe anti-pinch traction rope according to claim 3, wherein the linking outer shell is a hollow tubular structure internally provided with a stepped hole, a first ball locking hole section, a first ball unlocking hole section, a linking piece limiting hole section, a second ball locking hole section and a second ball unlocking hole section are successively arranged from one end to the other end of a pipe hole of the linking outer shell, a pore diameter of the first ball unlocking hole section is greater than, a pore diameter of the first ball locking hole section, a pore diameter of the second ball unlocking hole section is greater than a pore diameter of the second ball locking hole section, and a pore diameter of the linking piece limiting hole section, is greater than the pore diameter of the second ball locking hole section.

5. The passive safe anti-pinch traction rope according to claim 4, wherein the linking piece comprises a first stepped shaft section and a second stepped shaft section, wherein an outer pipe diameter of the first stepped shaft section is greater than an outer pipe diameter of the second stepped shaft section; and the pore diameter of the linking piece limiting hole section is smaller than the outer pipe diameter of the first stepped shaft section.

6. The passive safe anti-pinch traction rope according to claim 5, wherein the first ball locking hole section is in clearance fit with the first stepped shaft section, and the second ball locking hole section is in clearance fit with the second stepped shaft section.

7. The passive safe anti-pinch traction rope according to claim 6, wherein transition walls on the upper and lower sides of the first ball unlocking hole section are in transition arrangements of inclined planes, and a transition wall between the second ball unlocking hole section and the second ball locking hole section is in a transition arrangement of an inclined plane, so that the first ball and the second ball are in smooth transition at a joint of two adjacent inner hole walls of the stepped hole in the linking outer shell.

8. The passive safe anti-pinch traction rope according to claim 7, wherein transition walls on the upper and lower sides of the first ball limiting groove are in a transition arrangement of an inclined plane, so that it is convenient for the hook to push the first ball; and transition walls on the upper and lower sides of the second ball limiting groove are in a transition arrangement of an inclined plane, so that it is convenient for the hook to push the second ball.

9. The passive safe anti-pinch traction rope according to claim 8, wherein the spring is nested on the outer pipe wall of the second stepped shaft section of the linking piece, the linking piece nested with the spring is inserted into the linking outer shell of the first ball locking hole section, one end of the spring abuts against a shaft shoulder between the first ball locking hole section and the second ball locking hole section, and the other end of the spring abuts against a hole shoulder between the linking piece limiting hole section and the second ball locking hole section.

10. The passive safe anti-pinch traction rope according to claim 9, wherein the outer pipe wall at the lower end of the second stepped hole section of the linking piece is provided with a limiting piece mounting groove, and a limiting ring piece is nested in the limiting piece mounting groove; and the limiting ring piece is used for limiting the linking piece in the linking outer shell to limit the linking piece to move upwards outside the linking outer shell.

11. The passive safe anti-pinch traction rope according to claim 2, further comprising a traction rope outer sleeve, the traction rope outer sleeve is sleeved on, the outer surface of the linking outer shell, an outer side of the upper end of the linking outer shell is provided with a peripheral protrusion, the lower end of the linking outer shell is provided with a traction rope outer sleeve slot, and the traction rope outer sleeve slot is used for limiting and connecting the traction rope outer sleeve in a clamping manner.

12. The passive safe anti-pinch traction rope according to claim 10, wherein the first ball locking hole is formed in the first stepped shaft section, and a pore diameter thereof in one side of the hook mounting groove is smaller than a diameter of the first ball, so that the first ball is prevented from rolling outwards into the linking piece from the first ball locking hole.

13. The passive safe anti-pinch traction rope according to claim 12, wherein the second ball locking hole is formed in the second stepped shaft section outside the connecting piece mounting hole, and a pore diameter thereof in one side of the hook mounting groove is smaller than a diameter of the second ball, so that the second ball is prevented from rolling from the inner side of the second ball locking hole, and a part of the ball enters the connecting piece mounting hole through the second ball locking hole.
